(19) United States
(12) Patent Application Publication
(10) Pub. No.: US 2017/0152706 A1
(43) Pub. Date: Jun. 1, 2017

(54) FABRIC SHEET FORMING LOOP

(71) Applicant: DAEKYEONG TRIPLE CO., LTD., Daegu (KR)

(72) Inventor: Sang-Gun CHA, Daegu (KR)

(21) Appl. No.: 15/016,179

(22) Filed: Feb. 4, 2016

(30) Foreign Application Priority Data
Dec. 1, 2015 (KR) 10-2015-0170296

(51) Int. Cl. E06B 9/262; D03D 15/00; E06B 9/326; D03D 11/02; E06B 9/264; E06B 9/386

(52) U.S. Cl. CPC E06B 9/262; E06B 9/264; E06B 9/386; E06B 9/326; D03D 11/02; D03D 15/00; E06B 2009/2622

(57) ABSTRACT

The present invention relates to a fabric sheet forming a loop and the fabric sheet is configured to include: a loop fabric sheet 10; a dual fabric sheet 20 positioned on a rear surface of the loop fabric sheet 10; connection bands 30 formed on each of the top and the bottom of the loop fabric sheet 10 and the dual fabric sheet 20 in the longitudinal direction of a weft; and an interval control cord 50 of which one end is fixed to the bottom of the dual fabric sheet 20, a part is positioned in the dual fabric sheet 20, and the residual part is positioned outside the dual fabric sheet 20. As a result, even when the fabric sheet in which the loop is formed by using only fabrics is unfolded, the loop can be formed to form a regular loop and increase efficiency of production.

### CROSS-REFERENCE TO RELATED APPLICATION

This application is based on and claims the benefit of priority to Korean Patent Application No. 10-2015-0170296, filed on Dec. 1, 2015 in the Korean Intellectual Property Office, the disclosure of which is incorporated herein in its entirety by reference.

### TECHNICAL FIELD

The present invention relates to a fabric sheet forming a loop, and more particularly, to a fabric sheet forming a loop, in which a loop can be formed even when a fabric sheet is unfolded and the size of the loop can be controlled.

### BACKGROUND

A curtain is generally used for shading light or an article in a daily life, such as shading sunlight or shading a stage. Various types of curtains are present according to shapes thereof and the curtains include a general curtain unfolded and folded to left and right sides, a vertical blind constituted by a plurality of pieces controlling an inclination angle, a roll-screen curtain in which the curtain is rolled on and unrolled from a roll which rotates, a roman shade folded while being hinged by a winding operation of a length control wire, and the like.

In recent years, while an aesthetic element is also considered important as well as a function of the curtain, a roman shade of which a folded shape is elegant becomes popular. The roman shade is principally characterized in that as a curtain part rises while being folded, a plurality of layers are formed, and as a result, an exterior is elegant.

While the present applicant researches into various shapes of roman shades, the present applicant discovered a structure to form a regular loop and the roman shade is disclosed in Patent Document 1 when the roman shade is folded and unfolded. FIG. 1 is a perspective view illustrating the roman shade of Patent Document 1 and in Patent Document 1, two curtains 1 and 2 are arranged in line, a connection band 3 is formed between two curtains 1 and 2, and two cord lines 4 and 5 are provided to be installed between the curtains 1 and 2 as illustrated in FIG. 1. One 4 of two cord lines 4 and 5 is a component for folding and unfolding the curtains 1 and 2 and in the case of the other one 5, a fixation bead 6 is installed and thus, even though both the curtains 1 and 2 are unfolded, the curtains 1 and 2 are suspended on the fixation bead 6, the curtains 1 and 2 cannot be completely unfolded to form the loop.

However, even when the roman shade of Patent Document 1 is unfolded, the fixation bead 6 needs to be installed on the cord line 5 in order to form the loop and in this case, since the fixation bead 6 is installed on the cord line 5 only by a manual operation, it is difficult to implement the regular loop and productivity significantly deteriorates.

### SUMMARY

The present invention has been made in an effort to provide a fabric sheet forming a loop in which a loop is formed when a fabric sheet is unfolded by using the fabric sheet and the size of the loop can be controlled.

An embodiment of the present invention provides a fabric sheet forming a loop including: a loop fabric sheet; a dual fabric sheet positioned on a rear surface of the loop fabric sheet; a pair of connection bands formed on each of the top and the bottom of the loop fabric sheet and the dual fabric sheet in a longitudinal direction of a weft to connect the loop fabric sheet and the dual fabric sheet; at least one loop connection band formed in parallel to a pair of connection bands between a pair of connection bands to connect the loop fabric sheet and the dual fabric sheet; and an interval control cord installed in the dual fabric sheet and controlling the length of the dual fabric sheet to control the loop size of the loop fabric sheet.

Another embodiment of the present invention provides a fabric sheet forming a loop including: a loop fabric sheet; a sub loop fabric sheet positioned on a rear surface of the loop fabric sheet; a dual fabric sheet positioned between the loop fabric sheet and the sub loop fabric sheet; a pair of connection bands formed on each of the top and the bottom of the loop fabric sheet, the sub loop fabric sheet, and the dual fabric sheet in a longitudinal direction of a weft to connect the loop fabric sheet, the sub loop fabric sheet, and the dual fabric sheet; at least one loop connection band formed in parallel to the connection bands between a pair of connection bands to connect the loop fabric sheet, the sub loop fabric sheet, and the dual fabric sheet; and an interval control cord installed in the dual fabric sheet and controlling the length of the dual fabric sheet to control the loop sizes of the loop fabric sheet and the sub loop fabric sheet.

In a fabric sheet forming a loop according to the present invention, a loop can be formed when a fabric sheet is unfolded by using only a fabric sheet to form a regular loop and control the size of the loop and the fabric sheet can be integrally formed through weaving to increase efficiency of production.

### BRIEF DESCRIPTION OF THE DRAWINGS

FIG. 1 is a perspective view illustrating a fabric sheet forming a loop of Patent Document 1.

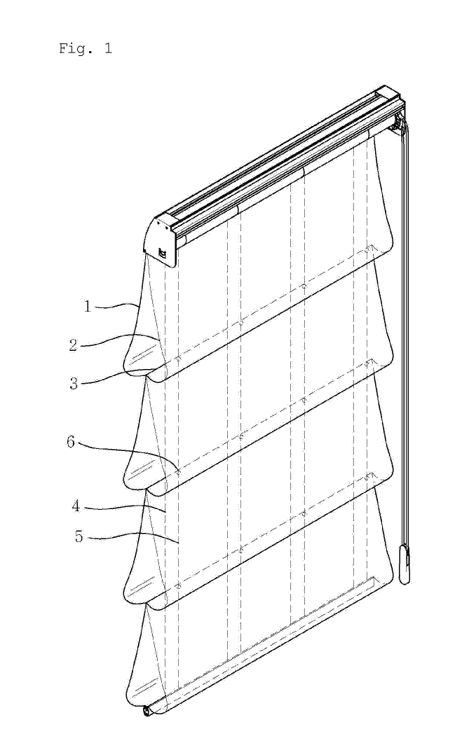

FIG. 2 is a perspective view illustrating a fabric sheet forming a loop according to the present invention to which a first embodiment of a dual fabric sheet is applied.

FIG. 3 is a conceptual diagram illustrating a fabric structure of a cross-section taken along line C1-C′1 of FIG. 2.

FIG. 4 is a conceptual diagram illustrating a fabric structure of a cross-section taken along line D1-D′1 of FIG. 2.

FIG. 5 is an operating state diagram of FIG. 2.

FIG. 6 is a perspective view illustrating a fabric sheet forming a loop according to the present invention to which a second embodiment of a dual fabric sheet is applied.

FIG. 7 is a conceptual diagram illustrating a fabric structure of a cross-section taken along line C2-C′2 of FIG. 6.

FIG. 8 is a conceptual diagram illustrating a fabric structure of a cross-section taken along line D2-D′2 of FIG. 6.

FIG. 9 is an operating state diagram of FIG. 5.

FIG. 10 is a perspective view illustrating a fabric sheet forming a loop according to the present invention to which a third embodiment of a dual fabric sheet is applied.

FIG. 11 is an operating state diagram of FIG. 10.

FIG. 12 is a perspective view illustrating that a first embodiment of a sub loop fabric sheet is applied to FIG. 2.

FIG. 13 is a conceptual diagram illustrating a fabric structure of a cross-section taken along line C3-C′3 of FIG. 8.

FIG. 14 is a conceptual diagram illustrating a fabric structure of a cross-section taken along line D3-D′3 of FIG. 8.

FIG. 15 is an operating state diagram of FIG. 12.

FIG. 16 is a perspective view illustrating that the first embodiment of a sub loop fabric sheet is applied to FIG. 6.

FIG. 17 is an operating state diagram of FIG. 16.

FIG. 18 is a perspective view illustrating that a second embodiment of a sub loop fabric sheet is applied to FIG. 2.

FIG. 19 is a conceptual diagram illustrating a fabric structure of a cross-section taken along line C4-C′4 of FIG. 18.

FIG. 20 is a conceptual diagram illustrating a fabric structure of a cross-section taken along line D4-D′4 of FIG. 18.

FIG. 21 is a conceptual diagram illustrating another embodiment of FIG. 19.

FIG. 22 is an operating state diagram of FIG. 18.

FIG. 23 is a perspective view illustrating that the second embodiment of a sub loop fabric sheet is applied to FIG. 6.

FIG. 24 is an operating state diagram of FIG. 23.

FIG. 25 is a perspective view illustrating that a traction cord is removed from FIG. 2.

FIG. 26 is a conceptual diagram illustrating a fabric structure of a cross-section taken along line C5-C′5 of FIG. 25.

FIG. 27 is a conceptual diagram illustrating a fabric structure of a cross-section taken along line D5-D′5 of FIG. 25.

FIG. 28 is an operating state diagram of FIG. 25.

### DETAILED DESCRIPTION

Hereinafter, a fabric sheet forming a loop according to the present invention will be described in more detail with reference to the accompanying drawings.

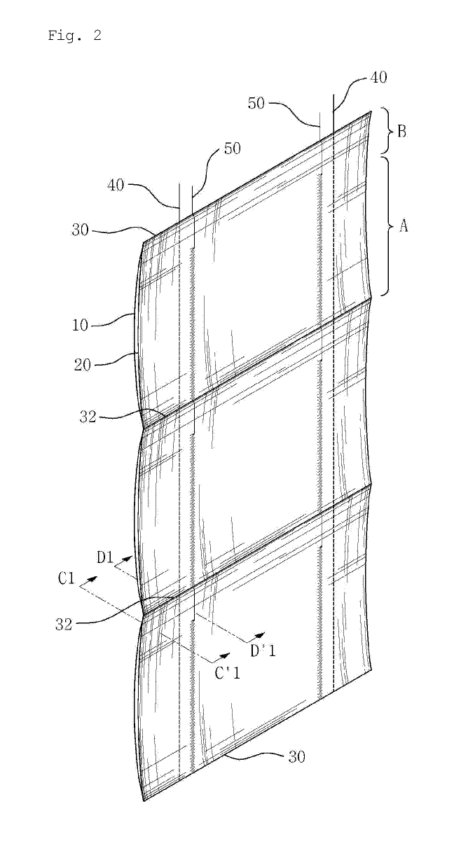

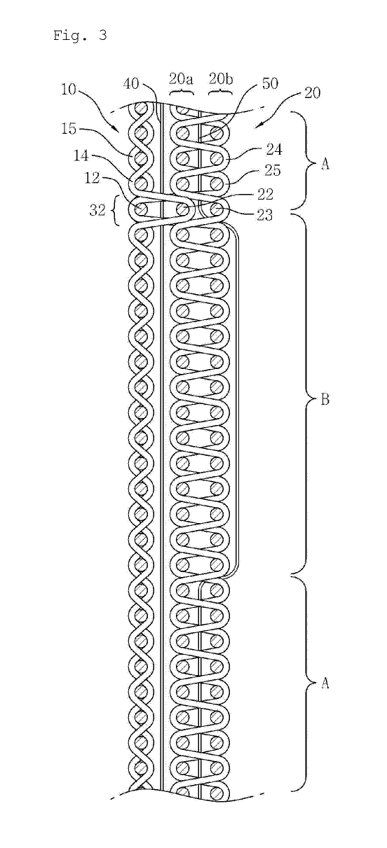

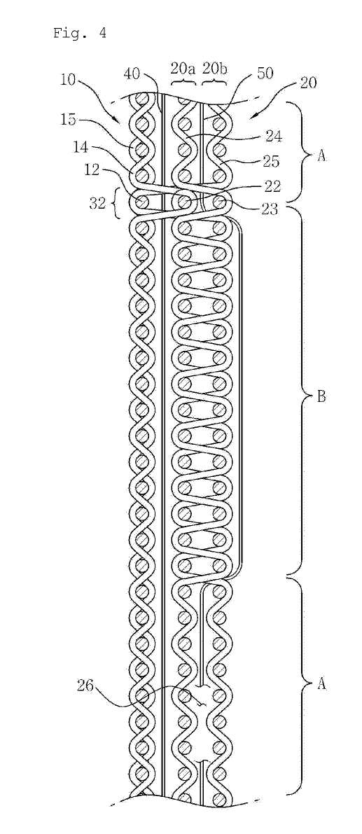

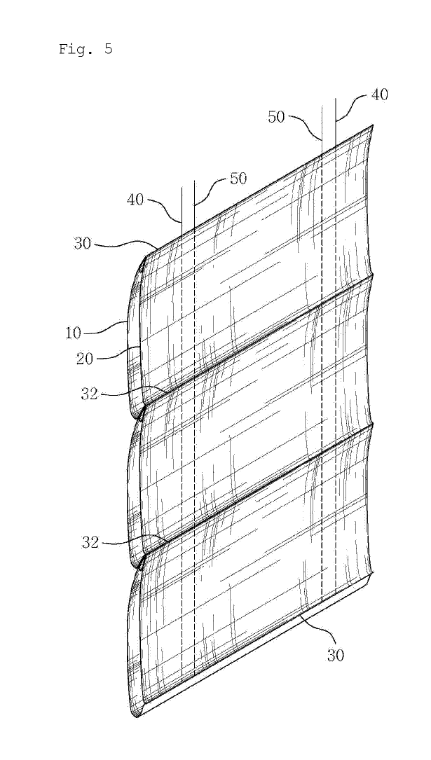

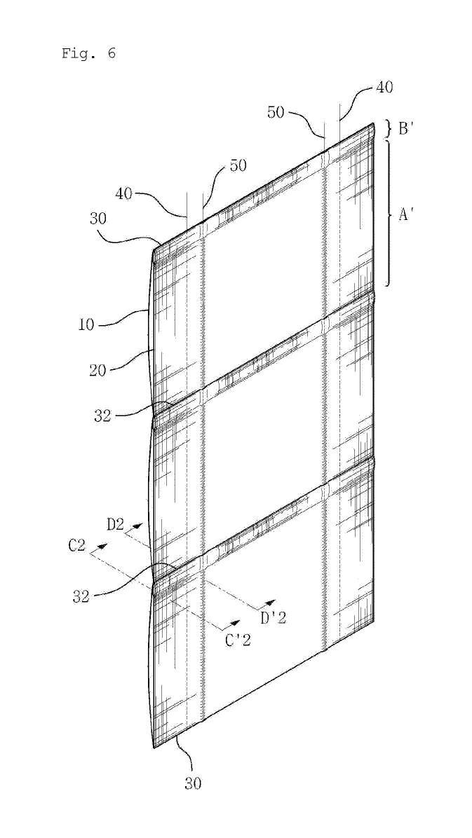

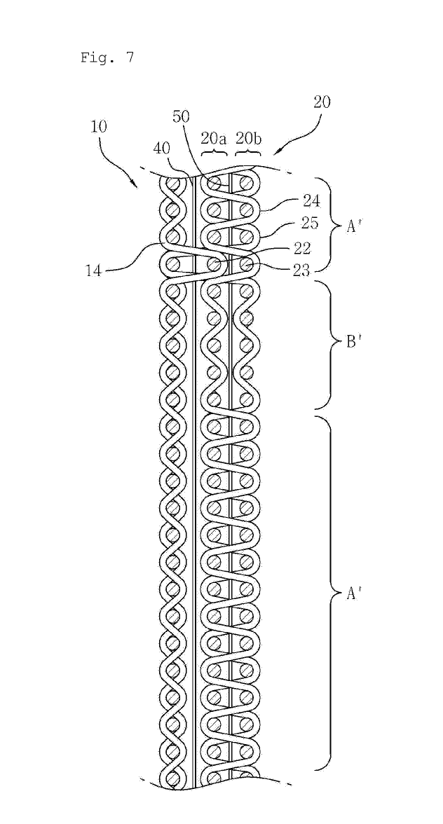

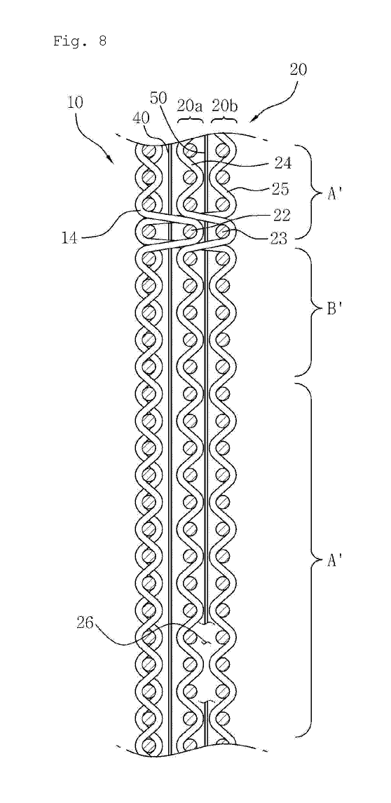

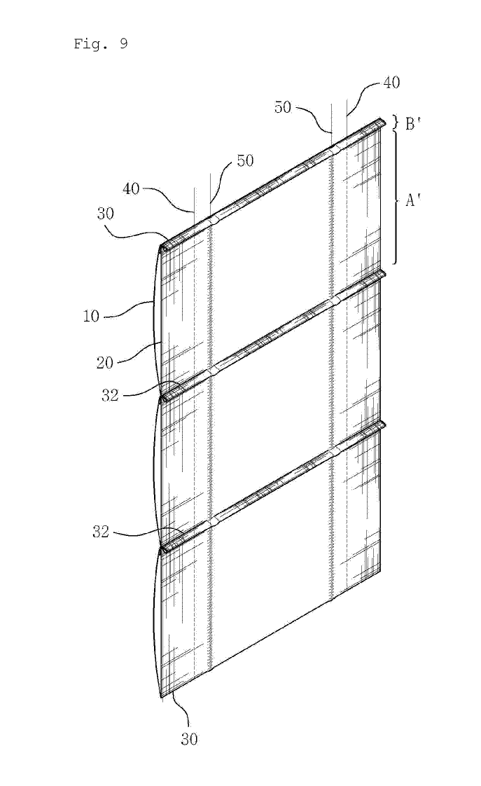

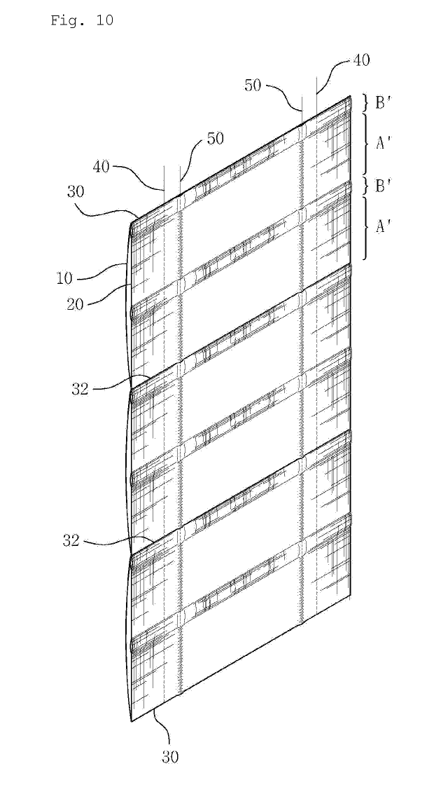

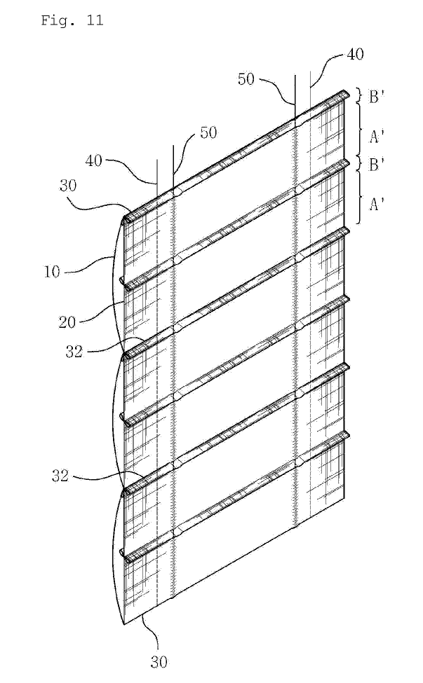

The present invention relates to a fabric sheet forming a loop. FIG. 2 is a perspective view illustrating a fabric sheet forming a loop according to the present invention to which a first embodiment of a dual fabric sheet is applied. FIG. 3 is a conceptual diagram illustrating a fabric structure of a cross-section taken along line C1-C′1 of FIG. 2. FIG. 4 is a conceptual diagram illustrating a fabric structure of a cross-section taken along line D1-D′1 of FIG. 2. FIG. 5 is an operating state diagram of FIG. 2. FIG. 6 is a perspective view illustrating a fabric sheet forming a loop according to the present invention to which a second embodiment of a dual fabric sheet is applied. FIG. 7 is a conceptual diagram illustrating a fabric structure of a cross-section taken along line C2-C′2 of FIG. 6. FIG. 8 is a conceptual diagram illustrating a fabric structure of a cross-section taken along line D2-D′2 of FIG. 6. FIG. 9 is an operating state diagram of FIG. 5. FIG. 10 is a perspective view illustrating a fabric sheet forming a loop according to the present invention to which a third embodiment of a dual fabric sheet is applied. FIG. 11 is an operating state diagram of FIG. 10.

A fabric sheet forming a loop according to the present invention is configured to include a loop fabric sheet 10; a dual fabric sheet 20 positioned on a rear surface of the loop fabric sheet 10; a pair of connection bands 30 formed on each of the top and the bottom of the loop fabric sheet 10 and the dual fabric sheet 20 in the longitudinal direction of a weft to the loop fabric sheet 10 and the dual fabric sheet 20; at least one loop connection band 32 formed in parallel to a pair of connection bands 30 between a pair of connection bands 30 to connect the loop fabric sheet 10 and the dual fabric sheet 20; a traction cord 40 of which one end is fixed to the bottom of the loop fabric sheet 10 to fold or unfold the loop fabric sheet 10; and an interval control cord 50 installed in the dual fabric sheet 20 and controlling the length of the dual fabric sheet 20 to control the loop size of the loop fabric sheet 10.

Prior to describing each component, in the case of describing an operating member (not illustrated) required when the fabric sheet forming the loop according to the present invention is actually installed in brief, the operating member is constituted by a rotation rod, a frame, and a traction line. The rotation rod is a component that rotates with a cylindrical rod shape. The frame is connected with both ends (rotational shafts) of the rotation rod therein to rotate the rotation rod and is fixed to a place where a curtain is installed. The traction line is installed on one end of the rotation rod and when a user operates the traction line, the traction line may rotate the rotation rod. The operating member is disclosed in Application No. 10-2013-0096139 and the operating member is described with reference to Application No. 10-2013-0096139.

Hereinafter, each component will be described in detail.

As the fabric sheet in which the loop is formed when the loop fabric sheet 10 is folded or unfolded, a single-face fabric sheet formed in a structure in which a first weft 12 and first and first′ warps 15 are woven is provided. When the loop fabric sheet 10 is applied to a roman shade, the loop fabric sheet 10 is used by a scheme in which the loop fabric sheet 10 is fixed to the frame and thereafter, folded by the traction cord 40 to be described below and the loop fabric sheet 10 is directly connected to the rotation rod as necessary to be used as a roll screen type.

The dual fabric sheet 20 as a component to form the loop even when the loop fabric sheet 10 is unfolded is constituted by a first fabric sheet 20a and a second fabric sheet 20b and an unfolded length is controlled by the interval control cord 50 to be described below, and as a result, the loop is formed or not formed in the loop fabric sheet 10. The first fabric sheet 20a is constituted by a second weft 22 and a second warp 24 and the second fabric sheet 20b is constituted by a second′ weft 23 and a second′ warp 25. The dual fabric sheet 20 is positioned on the rear surface of the loop fabric sheet 10 and is connected with the loop fabric sheet 10 through the connection bands 30 and the loop connection band 32 to be described below.

In addition, the dual fabric sheet 20 is divided into two types in a structure in which the first fabric sheet 20a and the second fabric sheet 20b are connected and first, a structure (hereinafter referred to as a first embodiment structure of the dual fabric sheet 20) is provided, in which the first fabric sheet 20a and the second fabric sheet 20b are completely connected through weaving and a structure (hereinafter referred to as a second embodiment structure of the dual fabric sheet 20) is provided, in which the first fabric sheet 20a and the second fabric sheet 20b are connected through weaving, however, the first fabric sheet 20a and the second fabric sheet 20b are connected in addition to parts where the first fabric sheet 20a and the second fabric sheet 20b are not connected in the longitudinal direction of the weft in a predetermined section.

The first embodiment structure of the dual fabric sheet 20 is the structure illustrated in FIG. 2 and in detail, as illustrated in FIG. 3, the second weft 22 and the second′ weft 23 are arranged in line and the second warp 24 and the second′ warp 25 cross each other and are thus woven with the second weft 22 and the second′ weft 23 to be connected with each other. At Location A at which the interval control cord 50 is positioned in the dual fabric sheet 20 among locations through which the interval control cord 50 to be described below passes, the second warp 24 of the first fabric sheet 20a and the second′ warp 25 of the second fabric sheet 20b do not cross each other as illustrated in FIG. 4 to form a through-hole 26. As a result, the interval control cord 50 may freely move in the dual fabric sheet 20. Of course, At Location A at which the interval control cord 50 is positioned outside the dual fabric sheet 20 among the locations through which the interval control cord 50 passes, the second warp 24 of the first fabric sheet 20a and the second′ warp 25 of the second fabric sheet 20b may not cross each other. Consequently, the dual fabric sheet 20 is a basic type and two warps 24 and 25 are woven while cross each other, and as a result, the dual fabric sheet 20 is constituted by bifold fabric sheets and at the location through which the interval control cord 50 passes, two warps 24 and 25 are woven with the second weft 22 and the second′ weft 23, respectively to form the through-hole 26. Therefore, friction between the dual fabric sheet 20 and the interval control cord 50 is minimized, and as a result, the interval control cord 50 freely moves in the dual fabric sheet 20.

The second embodiment structure of the dual fabric sheet 20 is the structure illustrated in FIG. 6 and in detail, as illustrated in FIG. 7, the second weft 22 and the second′ weft 23 are arranged in line and in section A′, the second warp 24 and the second′ warp 25 cross each other and in section B′, the second warp 24 and the second′ warp 25 do not cross each other and the second warp 24 is woven with the second weft 22 and the second′ warp 25 is woven with the second′ weft 23. In addition, in section A′, the second warp 24 and the second′ warp 25 cross each other again and are thus woven with the second weft 22 and the second′ weft 23 to be connected with each other. Next, a part through which the interval control cord 50 passes, the second warp 24 of the first fabric sheet 20a and the second′ warp 25 of the second fabric sheet 20b do not cross each other as illustrated in FIG. 8 to form the through-hole 26. As a result, the interval control cord 50 may freely move in the dual fabric sheet 20.

The reasons for dividing the dual fabric sheet 20 as two embodiments is associated with the location of the interval control cord 50 to be described below and a detailed matter associated therewith is described at the time of describing the interval control cord 50.

The connection band 30 is the part which is formed between the loop fabric sheet 10 and the dual fabric sheet 20 to connect the loop fabric sheet 10 and the dual fabric sheet 20. The connection band 30 is primarily formed on each of the top and the bottom of the loop fabric sheet 10 and the dual fabric sheet 20 and formed in a horizontal direction (the longitudinal direction of the weft) of the dual fabric sheet 20. The connection band 30 may be formed by two schemes and as a first scheme, the connection band 30 may be formed through crossing of fabrics and as a second scheme, the connection band 30 may be formed through bonding. When the connection band 30 is formed through crossing of the fabrics, since the fabric sheet forming the loop according to the present invention may be integrally woven and fabricated, a fabrication time is shortened and an additional process is not required, thereby remarkably improving productivity. In addition, when the connection band 30 is formed through the bonding, the loop fabric sheet 10 and the dual fabric sheet 20 are bonded by using an adhesive agent generally used in a textile field. This scheme is disadvantageous in that since the bonding process needs to be additionally performed, the productivity slightly deteriorates as compared with the crossing scheme of the fabrics.

The loop connection band 32 is formed between the top and the bottom of the loop fabric sheet 10 and the dual fabric sheet 20 to form multiple loops in the loop fabric sheet 10. The loop connection band 32 is formed in the horizontal direction (the longitudinal direction of the weft) of the loop fabric sheet 10 and the dual fabric sheet 20 and formed through crossing of threads constituting the fabric sheet or bonding using the adhesive agent similarly to the connection band 30. For reference, when the loop connection band 32 is formed through the bonding, the loop connection band 32 is not bonded to the locations through which the traction cord 40 and the interval control cord 50 to be described below pass. When the loop connection band 30 is formed through crossing of the fabrics, the first warp 14 of the loop fabric sheet 10 and the second warp 24 or the second′ warp 25 of the dual fabric sheet 20 cross each other and the first warp 14 is woven with the second weft 22 or the second′ weft 23 and the second warp 24 or the second′ warp 25 is woven with the first weft 12 and thereafter, crosses the first weft 12 again and returns to the original location and is woven with the second weft 22 or the second′ weft 23 to form the connection band 30. Of course, the connection band 30 may be formed through crossing of the wefts as necessary.

Consequently, one loop may be formed in the loop fabric sheet 10 due to the connection bands 30 formed on the top and the bottom of the loop fabric sheet 10 and the dual fabric sheet 20 and additionally, when the loop connection band 32 is formed, one loop is additionally formed whenever one loop connection band 32 is formed.

The traction cord 40 is an optional component which is fixed to the bottom of the loop fabric sheet 10 to fold or unfold the loop fabric sheet 10 and whether the traction cord 40 is installed is determined according to a scheme in which the fabric sheet forming the loop according to the present invention is folded. That is, when the fabric sheet forming the loop is applied to the scheme in which the curtain is rolled on the rotation rod like the roll screen, the traction cord 40 is not installed and when the fabric sheet forming the loop is applied to the scheme in which the fabric sheet is folded while forming the loop like the roman shade, the traction cord 40 is installed. Hereinafter, the fabric sheet is described based on the fabric sheet forming the loop according to the present invention, which is formed in a roman shade type through installation of the traction cord 40.

In detail, one end of the traction cord 40 is fixed to the bottom of the loop fabric sheet 10 and the other end is positioned on the top of the loop fabric sheet 10. Primarily, the traction cord 40 is disposed between the loop fabric sheet 10 and the dual fabric sheet 20 and disposed to pass through the connection band 30. Further, the location of the traction cord 40 may vary depending on the shape of a sub loop fabric sheet 60 to be described below and this will be described together at the time of describing the sub loop fabric sheet 60.

In addition, the other end of the traction cord, that is, an end of the traction cord 40 not installed in the loop fabric sheet 10 is connected to the rotation rod of the operating member when the fabric sheet forming the loop according to the present invention is actually installed. As a result, when the rotation rod rotates, the traction cord 40 is rolled on the rotation rod, and as a result, the loop is formed in the loop fabric sheet 10.

The interval control cord 50 is a component for forming the loop in the loop fabric sheet 10 even when the loop fabric sheet 10 is fully unfolded and one end of the interval control cord 50 is fixed to the bottom of the dual fabric sheet 20 and the other end is connected to the rotation rod of the operating member in actual installation. In addition, the location of the interval control cord 50 varies depending on the embodiment of the dual fabric sheet 20.

First, in the case of the first embodiment structure of the dual fabric sheet 20, as illustrated in FIG. 4, in Part A, the interval control cord 50 is positioned between the first fabric sheet 20a and the second fabric sheet 20b in the dual fabric sheet 20 and in Part B, the interval control cord 50 escapes from the dual fabric sheet 20 to be positioned outside the dual fabric sheet 20. In this case, the interval control cord 50 may be positioned on either a front surface and the rear surface of the dual fabric sheet 20. Parts A and B divided herein are primarily between the connection band 30 and the connection band 30. As a result, when the interval control cord 50 is pulled, the dual fabric sheet 20 corresponding to Part A is just pulled together and the dual fabric sheet 20 corresponding to Part B is folded. Consequently, as the unfolded length of the dual fabric sheet 20 decreases due to the folded Part B as illustrated in FIG. 4, the loop is formed in the loop fabric sheet 10 connected with the dual fabric sheet 20 through the connection band 30.

Next, in the case of the second embodiment structure of the dual fabric sheet 20, as illustrated in FIG. 8, in both Parts A′ and B′, the interval control cord 50 is positioned between the first fabric sheet 20a and the second fabric sheet 20b in the dual fabric sheet 20. As a result, when the interval control cord 50 is pulled, the dual fabric sheet 20 corresponding to Part A′ is just pulled together and the dual fabric sheet 20 corresponding to Part B′ is folded. Consequently, as the unfolded length of the dual fabric sheet 20 decreases due to the folded Part B′ as illustrated in FIG. 9, the loop is formed in the loop fabric sheet 10 connected with the dual fabric sheet 20 through the connection band 30.

In the case of the fabric sheet forming the loop according to the present invention described above, the loop may be formed in the loop fabric sheet 10 by two schemes and primarily, when the traction cord 40 is rolled on the rotation rod, the traction cord 40 draws up the bottom of the loop fabric sheet 10 to form the loop (of course, this is a case in which the fabric sheet forming the loop according to the present invention is applied to the roman shade and is excluded when the fabric sheet forming the loop is applied to the roll screen) and when the interval control cord 50 is rolled on the rotation rod (including the case in which the interval control cord 50 is pulled), the length of the dual fabric sheet 20 decreases, and as a result, the loop is formed in the loop fabric sheet 10.

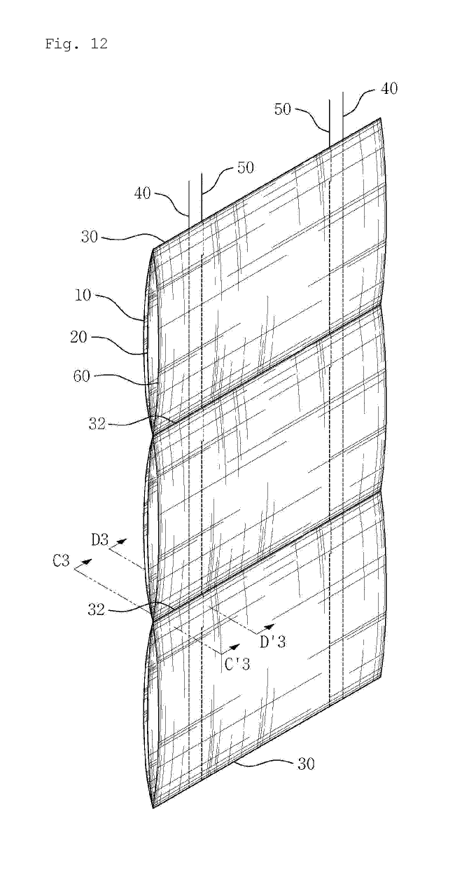

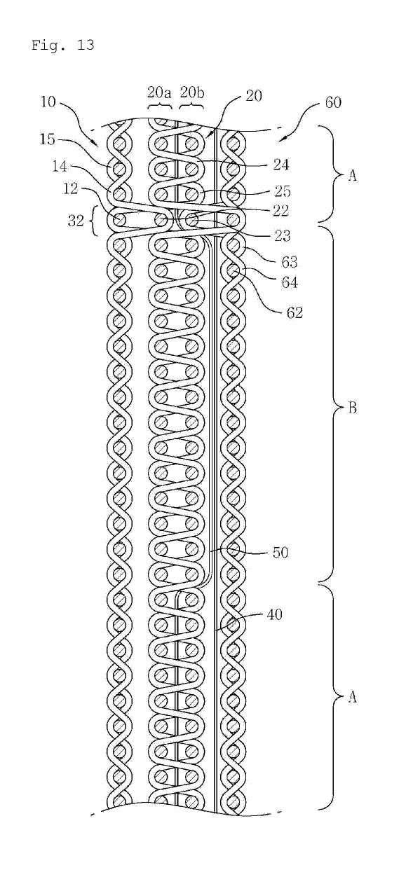

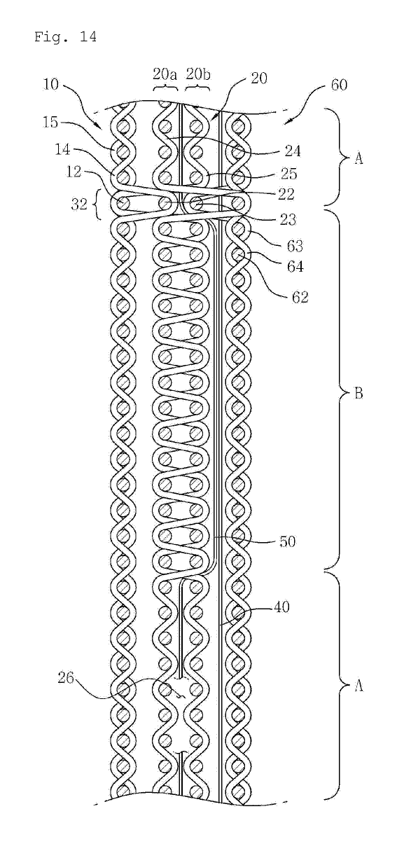

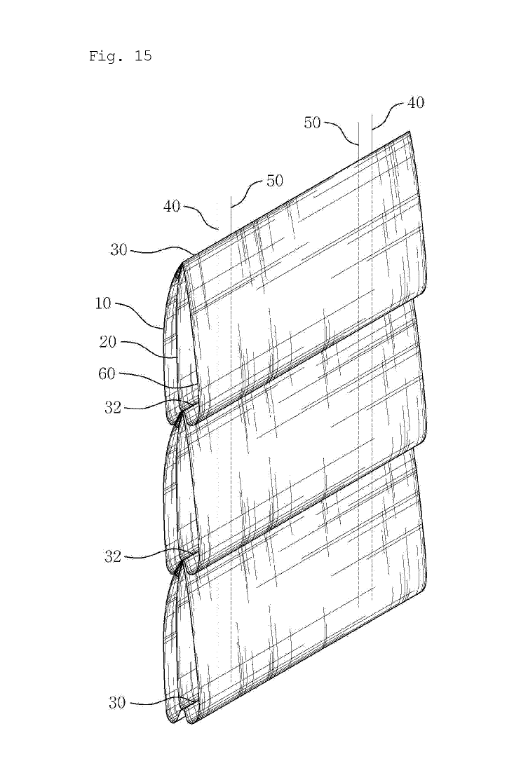

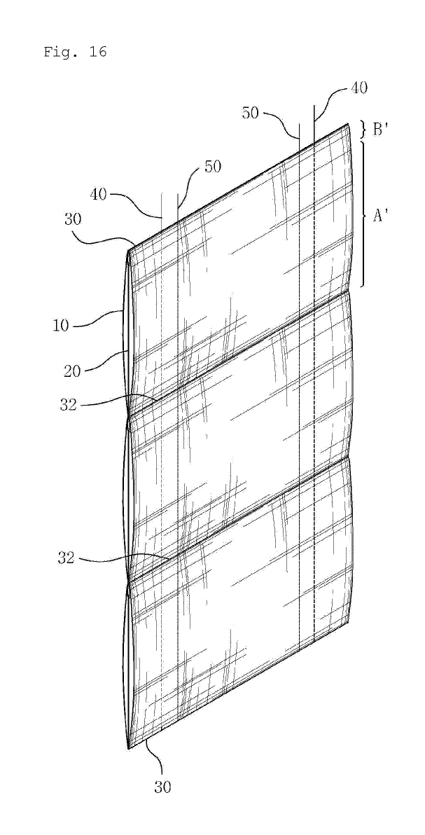

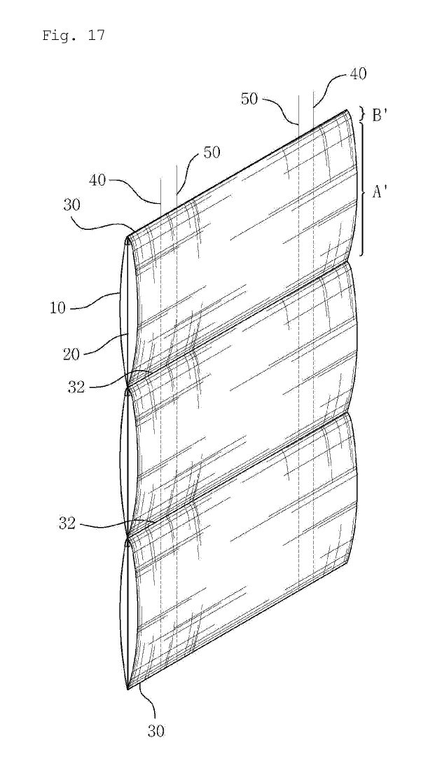

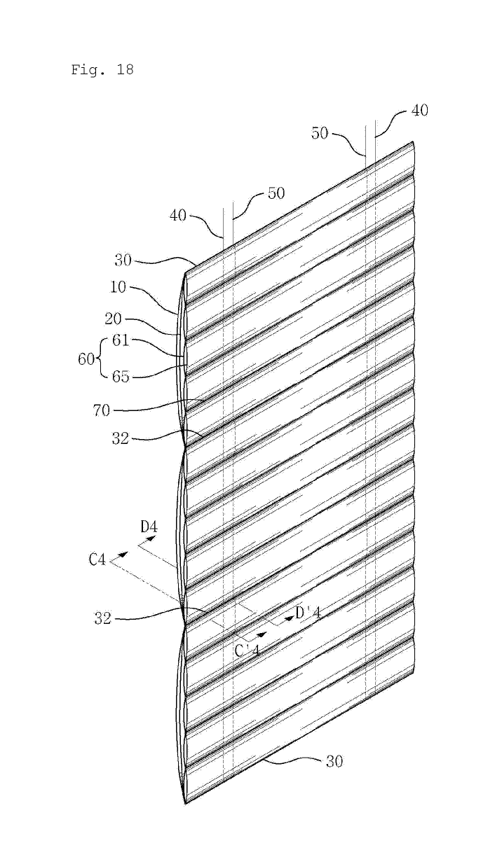

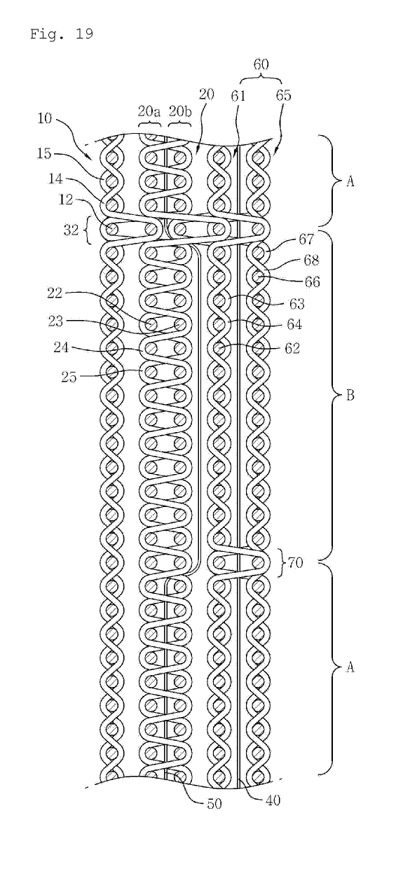

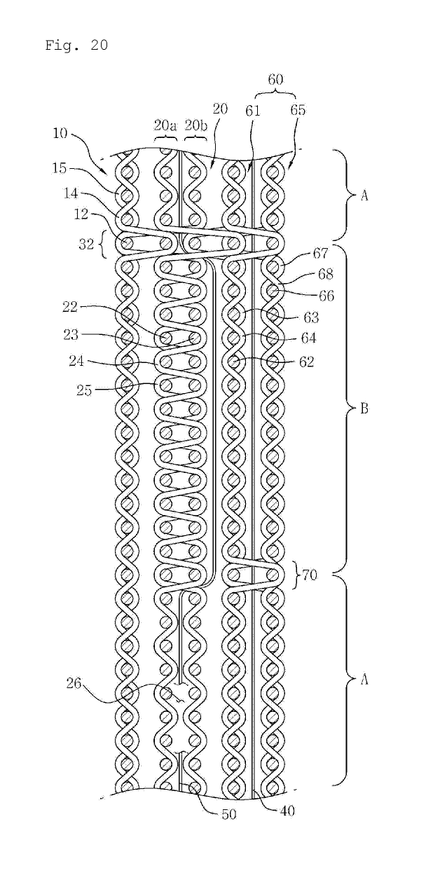

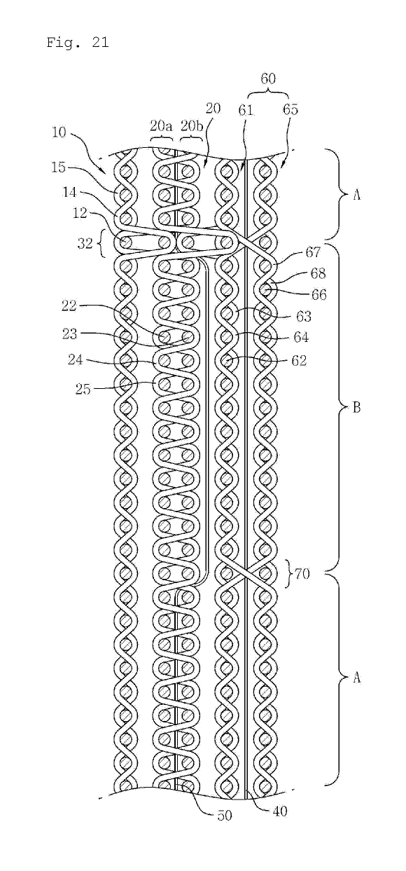

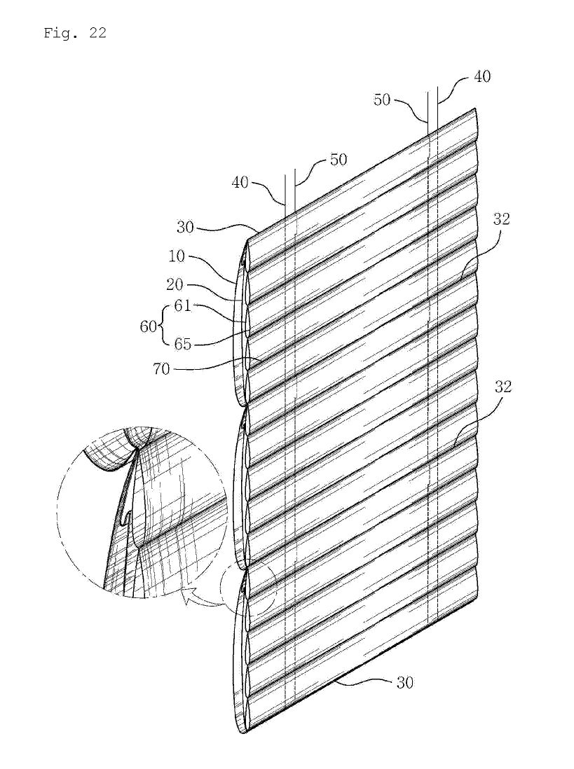

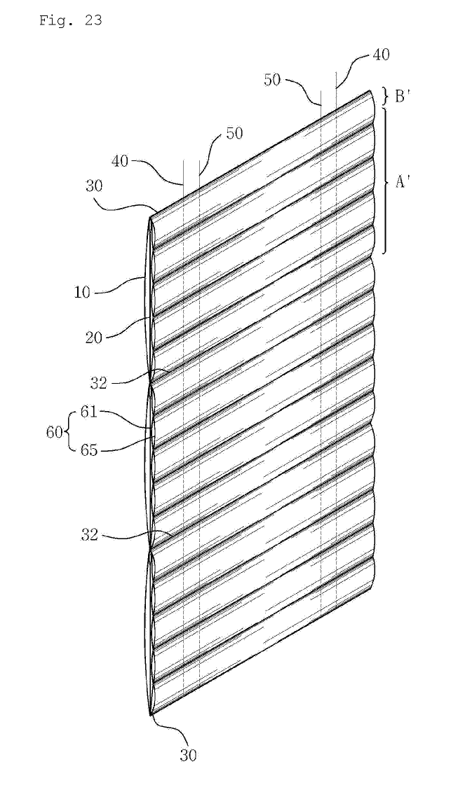

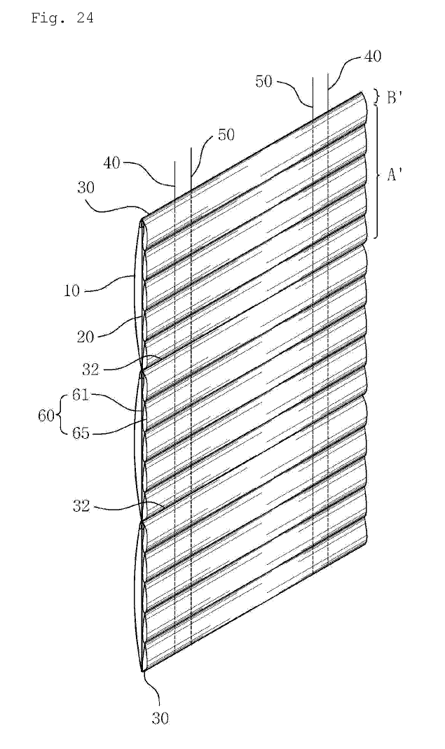

FIG. 12 is a perspective view illustrating that a first embodiment of a sub loop fabric sheet is applied to FIG. 2. FIG. 13 is a conceptual diagram illustrating a fabric structure of a cross-section taken along line C3-C′3 of FIG. 8. FIG. 14 is a conceptual diagram illustrating a fabric structure of a cross-section taken along line D3-D′3 of FIG. 8. FIG. 15 is an operating state diagram of FIG. 12. FIG. 16 is a perspective view illustrating that the first embodiment of a sub loop fabric sheet is applied to FIG. 6. FIG. 17 is an operating state diagram of FIG. 16. FIG. 18 is a perspective view illustrating that a second embodiment of a sub loop fabric sheet is applied to FIG. 2. FIG. 19 is a conceptual diagram illustrating a fabric structure of a cross-section taken along line C4-C′4 of FIG. 18. FIG. 20 is a conceptual diagram illustrating a fabric structure of a cross-section taken along line D4-D′4 of FIG. 18. FIG. 21 is a conceptual diagram illustrating another embodiment of FIG. 19. FIG. 22 is an operating state diagram of FIG. 18. FIG. 23 is a perspective view illustrating that a second embodiment of a sub loop fabric sheet is applied to FIG. 6. FIG. 24 is an operating state diagram of FIG. 23.

In the present invention, the sub loop fabric sheet 60 may be further provided and hereinafter, a state in which the sub loop fabric sheet 60 is provided will be described through the drawings.

The sub loop fabric sheet 60 as a component for forming the loop on both surfaces of the fabric sheet forming the loop according to the present invention is positioned on a surface on which the loop fabric sheet 10 is not positioned between the front surface and the rear surface of the dual fabric sheet 20. As the sub loop fabric sheet 60, various types of fabric sheets capable of forming the loop may be used, which include a fabric sheet constituted by a single sheet, a fabric sheet constituted by two sheets, and the like and the sub loop fabric sheet 60 will be described below through each embodiment.

First Embodiment of Sub Loop Fabric Sheet

In the first embodiment of the sub loop fabric sheet 60, the sub loop fabric sheet 60 is constituted by one fabric sheet like the loop fabric sheet 10 and as illustrated in FIG. 12, the sub loop fabric sheet 60 is disposed to be symmetric to the loop fabric sheet 10 based on the dual fabric sheet 20.

When a structure of the sub loop fabric sheet 60 is described, the sub loop fabric sheet 60 has a structure in which a third weft 62 and a third warp 63 are woven with each other as illustrated in FIG. 13.

In addition, when the sub loop fabric sheet 60 is formed, the connection band 30 is formed between the top and the bottom of the loop fabric sheet 10 and the dual fabric sheet 20 and between the top and the bottom of the dual fabric sheet 20 and the sub loop fabric sheet 60, each.

Further, the loop connection band 32 is formed at a location corresponding to the loop connection band 32 formed between the loop fabric sheet 10 and the dual fabric sheet 20. When the loop connection band 32 is formed by weaving the weft and the warp, the second warp 24 of the dual fabric sheet 20 and the third warp 63 of the sub loop fabric sheet 60 cross each other and thereafter, the second warp 24 is woven with the third weft 62 and the third warp 63 is woven with the second′ weft 23 and thereafter, the second warp 24 and the third warp 63 cross each other to original locations to form the loop connection band 32, as illustrated in FIG. 13. In addition, in the dual fabric sheet 20 at the location where the interval control cord 50 is installed, the second warp 24 and the second′ warp 25 do not cross each other to form the through-hole 26, and as a result, the interval control cord 50 may smoothly move in the dual fabric sheet 20 as illustrated in FIG. 14.

Consequently, when the interval control cord 50 is pulled, Part B of the dual fabric sheet 20 is folded and the length of the dual fabric sheet 20 decreases as illustrated in FIG. 15, and as a result, the loop is formed in the loop fabric sheet 10 and the sub loop fabric sheet 60.

In addition, when the first embodiment of the sub loop fabric sheet is applied to the second embodiment of the dual fabric sheet 20, the sub loop fabric sheet is disposed to be symmetric to the loop fabric sheet 10 based on the dual fabric sheet 20 as illustrated in FIG. 16. In addition, when the interval control cord 50 is pulled, the loop is formed in the loop fabric sheet 10 and the sub loop fabric sheet 60 as illustrated in FIG. 17.

Second Embodiment of Sub Loop Fabric Sheet

In the second embodiment of the sub loop fabric sheet 60, the sub loop fabric sheet 60 is constituted by two sheets and as illustrated in FIG. 18, multiple sub loop connection bands 70 are formed between two sub loop fabric sheets 60 in the longitudinal direction of the sub loop fabric sheet 60 to connect the sub loop fabric sheets 60. In addition, the traction cord 40 is installed in the sub loop fabric sheet 60 and installed in a structure in which one end is fixed to the bottom of the sub loop fabric sheet 60 and passes through the sub loop connection band 30.

When the structure of the sub loop fabric sheet 60 is described, the sub loop fabric sheet 60 is constituted by a total of two fabric sheets of a fabric sheet 61 formed by weaving the third weft 62 and the third and third′ warps 63 and 64 and a fabric sheet 65 formed by weaving the fourth weft 66 and the fourth and fourth′ warps 67 and 68 and the sub loop connection band 70 is formed between two fabric sheets 61 and 65. The sub loop connection band 70 may be formed by weaving the weft and the warp or formed through the bonding similarly to the connection band 30 and when the sub loop connection band 70 is formed by the weaving, the third warp 63 or the third′ warp 64 and the fourth warp 67 or the fourth′ warp 68 cross each other and thereafter, the third warp 63 is woven with the fourth weft 66 and the fourth warp 67 is woven with the third weft 62 and thereafter, woven while crossing to the original location again. In addition, in the dual fabric sheet 20 at the location where the interval control cord 50 is installed, the second warp 24 and the second′ warp 25 do not cross each other to form the through-hole 26, and as a result, the interval control cord 50 may smoothly move in the dual fabric sheet 20 as illustrated in FIG. 20.

Further, as illustrated in FIG. 21, a warp which initially crosses may not cross to the original location and but be woven.

In addition, the sub loop connection band 70 may be formed at the same location as the loop connection band 32 and as necessary, more frequently formed, and as a result, many loops may be formed in the sub loop fabric sheet 60. However, even in the latter case, the sub loop connection band 70 is also preferably formed at the location where the loop connection band 32 is formed.

Consequently, Part B of the dual fabric sheet 20 where the interval control cord 50 is positioned outside is folded and the length of the dual fabric sheet 20 thus decreases as illustrated in FIG. 22, and as a result, the loop is formed in the loop fabric sheet 10 and the sub loop fabric sheet 60.

In addition, when the second embodiment of the sub loop fabric sheet 60 is applied to the second embodiment of the dual fabric sheet 20, the sub loop fabric sheet 60 constituted by two fabric sheets 61 and 65 is positioned on the rear surface of the dual fabric sheet 20 as illustrated in FIG. 23 and in this state, when the interval control cord 50 is pulled, the length of the dual fabric sheet 20 decreases, and as a result, the loop is formed in the loop fabric sheet 10 and the sub loop fabric sheet 60 as illustrated in FIG. 24.

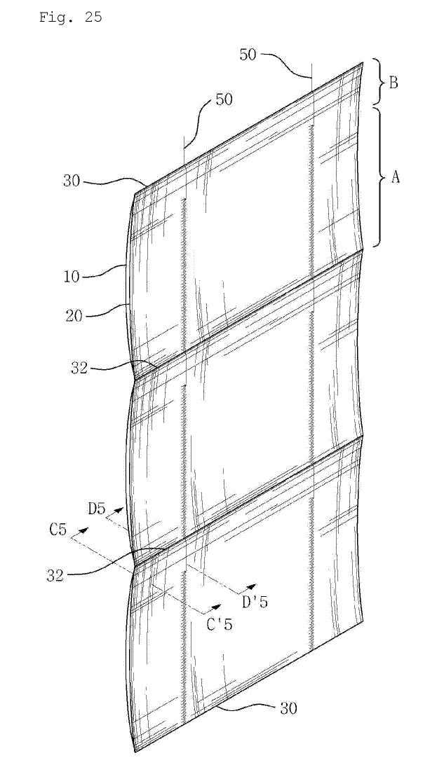

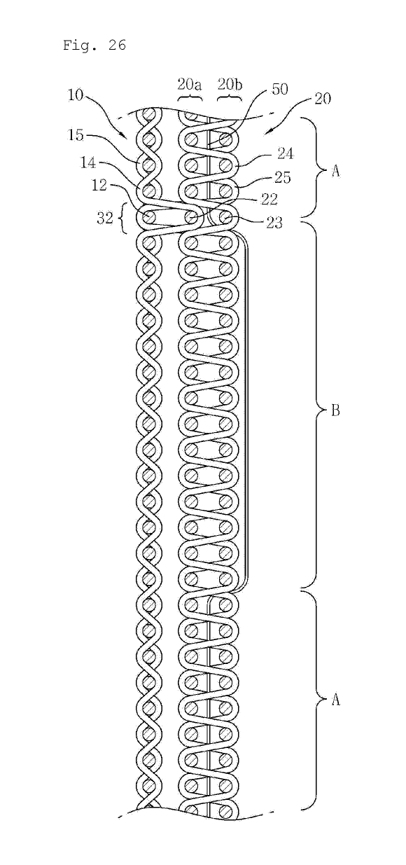

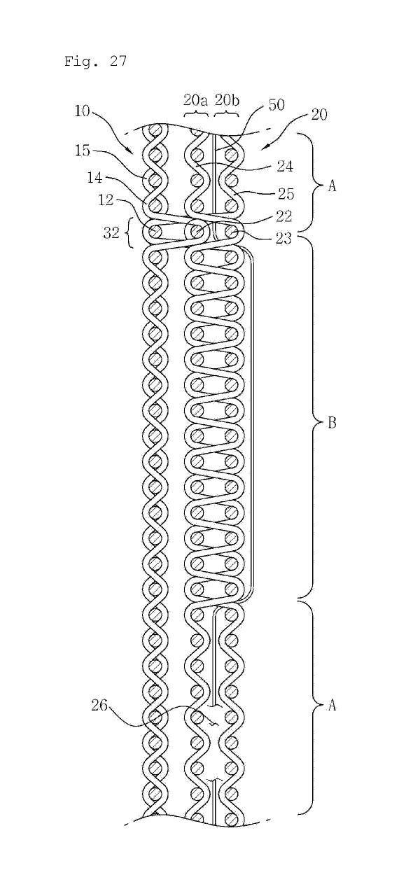

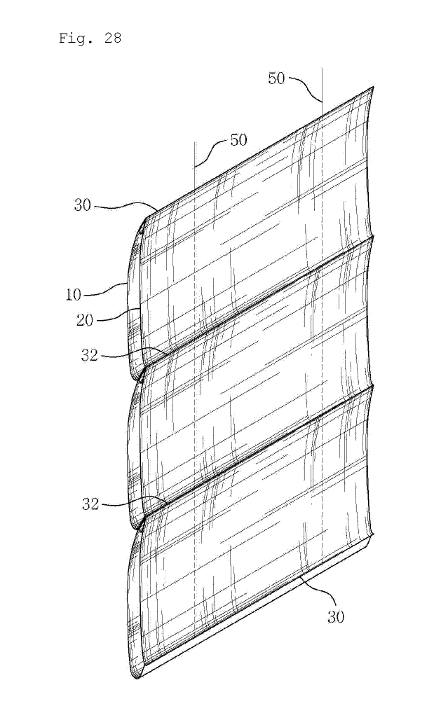

FIG. 25 is a perspective view illustrating that a traction cord is removed from FIG. 2. FIG. 26 is a conceptual diagram illustrating a fabric structure of a cross-section taken along line C5-C′5 of FIG. 25. FIG. 27 is a conceptual diagram illustrating a fabric structure of a cross-section taken along line D5-D′5 of FIG. 25. FIG. 28 is an operating state diagram of FIG. 25.

The fabric sheet forming the loop according to the present invention may be applied to the roll screen and in this case, the traction cord 40 is removed as illustrated in FIG. 25. In addition, since the structures of the loop fabric sheet 10 and the dual fabric sheet 20 and a connection relationship of the interval control cord 50 have been described in the first embodiment (see FIGS. 3 and 4) of the dual fabric sheet 20 described above, description thereof will be omitted.

Therefore, when the loop fabric sheet 10, the dual fabric sheet 20, and the sub loop fabric sheet 60 are installed by rotating the rotation rod of the operating member in the state illustrated in FIG. 25, the sub loop fabric sheet 60 is included and rolled and thereafter, the rotation rod rotates in a reverse direction and when the loop fabric sheet 10 and the dual fabric sheet 20 are unfolded and thereafter, the rotation rod additionally rotates as illustrated in FIG. 25, the interval control cord 50 is pulled, and as a result, the loop is formed in the loop fabric sheet 10 as illustrated in FIG. 28.

What is claimed is:

1. A fabric sheet forming a loop, comprising:
a loop fabric sheet 10;
a dual fabric sheet 20 positioned on a rear surface of the loop fabric sheet 10;
a pair of connection bands 30 formed on each of the top and the bottom of the loop fabric sheet 10 and the dual fabric sheet 20 in a longitudinal direction of a weft to connect the loop fabric sheet 10 and the dual fabric sheet 20; at least one loop connection band 32 formed in parallel to a pair of connection bands 30 between a pair of connection bands 30 to connect the loop fabric sheet 10 and the dual fabric sheet 20; and
an interval control cord 50 installed in the dual fabric sheet 20 and controlling the length of the dual fabric sheet 20 to control a loop size of the loop fabric sheet 10.

2. A fabric sheet forming a loop, comprising:
a loop fabric sheet 10;
a sub loop fabric sheet 60 positioned on a rear surface of the loop fabric sheet 10;
a dual fabric sheet 20 positioned between the loop fabric sheet 10 and the sub loop fabric sheet 60;
a pair of connection bands 30 formed on each of the top and the bottom of the loop fabric sheet 10, the sub loop fabric sheet 60, and the dual fabric sheet 20 in a longitudinal direction of a weft to connect the loop fabric sheet 10, the sub loop fabric sheet 60, and the dual fabric sheet 20; at least one loop connection band 32 formed in parallel to the connection bands 30 between a pair of connection bands 30 to connect the loop fabric sheet 10, the sub loop fabric sheet 60, and the dual fabric sheet 20; and
an interval control cord 50 installed in the dual fabric sheet 20 and controlling the length of the dual fabric sheet 20 to control loop sizes of the loop fabric sheet 10 and the sub loop fabric sheet 60.

3. The fabric sheet of claim 1, further comprising:
a traction cord 40 of which one end is fixed to the bottom of the loop fabric sheet 10 to fold or unfold the loop fabric sheet 10.

4. The fabric sheet of claim 2, further comprising:
a traction cord 40 of which one end is fixed to the bottom of the loop fabric sheet 10 or the bottom of the sub loop fabric sheet 60 to fold or unfold the loop fabric sheet 10 and the sub loop fabric sheet 60.

5. The fabric sheet of claim 1, wherein:
the dual fabric sheet 20 is constituted by a first fabric sheet 20a and a second fabric sheet 20b positioned on a rear surface of the first fabric sheet 20a and connected with the first fabric sheet 20a through weaving and the surface is divided based on a location where the loop connection band 32 is formed, and
a part of the interval control cord 50 is positioned in the dual fabric sheet 20 for each divided surface of the dual fabric sheet 20 and the residual part is positioned outside the dual fabric sheet 20 and one end is fixed to the bottom of the dual fabric sheet 20 and the other end is positioned on the top of the dual fabric sheet 20.

6. The fabric sheet of claim 2, wherein:
the dual fabric sheet 20 is constituted by a first fabric sheet 20a and a second fabric sheet 20b positioned on a rear surface of the first fabric sheet 20a and connected with the first fabric sheet 20a through weaving and the surface is divided based on a location where the loop connection band 32 is formed, and
a part of the interval control cord 50 is positioned in the dual fabric sheet 20 for each divided surface of the dual fabric sheet 20 and the residual part is positioned outside the dual fabric sheet 20 and one end is fixed to the bottom of the dual fabric sheet 20 and the other end is positioned on the top of the dual fabric sheet 20.

7. The fabric sheet of claim 5, wherein:
a through hole 26 is formed between the first fabric sheet 20a and the second fabric sheet 20b in the longitudinal direction of the warp; and
the interval control cord 50 passes through the through hole 26.

8. The fabric sheet of claim 6, wherein:
a through hole 26 is formed between the first fabric sheet 20a and the second fabric sheet 20b in the longitudinal direction of the warp; and
the interval control cord 50 passes through the through hole 26.

9. The fabric sheet of claim 1, wherein:
the dual fabric sheet 20 is constituted by a first fabric sheet 20a of which surfaces are divided based on the location where the loop connection band 32 is formed and a second fabric sheet 20b positioned on the rear surface of the first fabric sheet 20a and connected with the first fabric sheet 20a through the weaving and not connected with the first fabric sheet 20a in the longitudinal direction of the weft in a predetermined section for each divided surface, and
the interval control cord 50 is positioned in the dual fabric sheet 20, and one end of the interval control cord 50 is fixed to the bottom of the dual fabric sheet 20 and the other end is positioned on the top of the dual fabric sheet 20.

10. The fabric sheet of claim 2, wherein:
the dual fabric sheet 20 is constituted by a first fabric sheet 20a of which surfaces are divided based on the location where the loop connection band 32 is formed and a second fabric sheet 20b positioned on the rear surface of the first fabric sheet 20a and connected with the first fabric sheet 20a through the weaving and not connected with the first fabric sheet 20a in the longitudinal direction of the weft in a predetermined section for each divided surface, and
the interval control cord 50 is positioned in the dual fabric sheet 20, and one end of the interval control cord 50 is fixed to the bottom of the dual fabric sheet 20 and the other end is positioned on the top of the dual fabric sheet 20.

11. The fabric sheet of claim 9, wherein:
a through hole 26 is formed between the first fabric sheet 20a and the second fabric sheet 20b in the longitudinal direction of the warp, and
the interval control cord 50 passes through the through hole 26.

12. The fabric sheet of claim 10, wherein:
a through hole 26 is formed between the first fabric sheet 20a and the second fabric sheet 20b in the longitudinal direction of the warp, and
the interval control cord 50 passes through the through hole 26.

13. The fabric sheet of claim 1, wherein the connection band 30 and the loop connection band 32 are formed by crossing threads constituting the fabric sheets.

14. The fabric sheet of claim 2, wherein the connection band 30 and the loop connection band 32 are formed by crossing threads constituting the fabric sheets.

15. The fabric sheet of claim 1, wherein the connection band 30 and the loop connection band 32 are formed by bonding the fabric sheets to each other.

16. The fabric sheet of claim 2, wherein the connection band 30 and the loop connection band 32 are formed by bonding the fabric sheets to each other.
